(19) United States
(12) Patent Application Publication
(10) Pub. No.: US 2015/0016765 A1
(43) Pub. Date: Jan. 15, 2015

(54) METHOD, RING & BEARING

(71) Applicants: Patrik Dahlman, Shanghai (CN); Viktor Recina, Torslanda (SE)

(72) Inventors: Patrik Dahlman, Shanghai (CN); Viktor Recina, Torslanda (SE)

(21) Appl. No.: 14/367,884

(22) PCT Filed: Nov. 26, 2012
(86) PCT No.: PCT/SE2012/000195

§ 371 Date: Jun. 20, 2014

(30) Foreign Application Priority Data
Dec. 20, 2011 (SE) 1100940-4

(51) Int. Cl. F16C 33/64; B23P 15/00; B23K 11/04

(52) U.S. Cl. CPC F16C 33/64; B23K 11/04; B23P 15/003
USPC 384/622; 219/100; 29/898

(57) ABSTRACT

A method for manufacturing a component from steel, which comprises the step of flash butt welding the component. The steel has a reduction ratio of greater than 5:1.

### CROSS REFERENCE TO RELATED APPLICATIONS

This is a National Stage application claiming the benefit of International Application Number PCT/SE2012/000195 filed on Nov. 26, 2012 (26.11.2012), which claims the benefit of Sweden Patent Application Number SE20110000940 filed on Dec. 20, 2011 (20.12.2011), both of which are incorporated herein by reference in their entireties.

### TECHNICAL FIELD

The present invention concerns a method for manufacturing a component, such as a bearing ring, from steel. The present invention also concerns a ring and a bearing comprising such a ring.

### BACKGROUND OF THE INVENTION

Forging is a manufacturing process involving the shaping of metal using localized compressive forces. As the metal is shaped during the forging process, its internal grain deforms to follow the general shape of the part. As a result, the grain is continuous throughout the part, giving rise to a piece with improved strength characteristics. Steel is almost always hot forged since hot forging prevents the work hardening that would result from cold forging, which would increase the difficulty of performing secondary machining operations on the piece. A high temperature furnace is required to heat steel ingots or billets, and large forging hammers and presses and/or metal-forming dies are used to compress the ingots or billets.

Steel bars may be produced from a forged ingot or billet and such a steel bar may be used to manufacture a ring. The steel bar may namely be formed into a ring and the ends of the ring may be welded together, by flash butt welding. Flash-butt welding is a resistance welding technique for joining segments of metal rail, rod, chain or pipe in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two edges to be welded, an upset force is suddenly applied to complete the weld. This upset force extrudes slag, oxides and molten metal from the weld zone leaving a welding accretion in the colder zone of the heated metal. The joint is then allowed to cool slightly before the clamps are opened to release the welded article. The welding accretion may be left in place or removed by shearing while the welded article is still hot or by grinding, depending on the requirements.

### SUMMARY OF THE INVENTION

An object of the invention is to provide an improved method for manufacturing a component that is to be flash butt welded from steel.

This object is achieved by a method comprising the step of flash butt welding steel that has a reduction ratio of greater than 5:1.

The expression “reduction ratio” as used in this document refers to the extent of area compression in the production of steel, by forging from a slab, bloom or billet, or cutting from a forged slab bloom or billet for example. A reduction ratio in metal forging can be calculated by dividing the cross sectional area of metal before forging by the cross sectional area of the metal after forging. The inventors have found that the combination of using highly reduced material (i.e. material having a reduction ratio of greater than 5:1) when manufacturing a component that is to be flash butt welded improves the mechanical properties of the component as compared to the case where highly reduced material is not used. For example, the rolling contact fatigue of a bearing ring manufactured using a method according to an embodiment of the invention is improved as compared to a bearing ring having a reduction ratio of less than 5:1.

According to an embodiment of the invention the component is a ring and the method comprises the steps of forming at least one steel bar into at least one ring segment and flash butt welding the ends of the at least one ring segment to make a ring, whereby the at least one steel bar has a reduction ratio of greater than 5:1. A ring is therefore constructed from a single ring segment that constitutes the entire ring once the ends of the ring segment have been flash butt welded together. Alternatively a ring is constructed from a plurality of ring segments each constituting part of the ring, whereby an entire ring is formed once the ends of adjacent ring segments have been flash butt welded together.

According to an embodiment of the invention the method comprises the step of producing a forged steel slab, bloom, or billet having a reduction ratio of greater than 5:1, greater than 6:1, greater than 7:1, greater than 8:1 or greater than 9:1. A slab, bloom, or billet may be forged from an ingot weighing over 4 ton, over 10 ton, over 15 ton, over 20 ton or more. At least one steel bar may be forged or cut from the slab bloom or billet. A billet is a length of metal that has a round or square cross-section, with an area less than 230 cm2. A bloom is similar to a billet except its cross-sectional area is greater than 230 cm2. A slab is a length of metal that is rectangular in cross-section.

According to another embodiment of the invention the method comprises the step of forming a plurality of steel bars into a plurality of ring segments where each ring segment constitutes 50%, 25%, 15% or less than 15% of a ring when the ring segments have been flash butt welded together to make the ring. It should be noted that a plurality of ring segments of different sizes may alternatively be flash butt welded together to make a ring.

According to another embodiment of the invention the ring is a bearing ring. The method according to the present invention is particularly, but not exclusively suitable for the manufacture of large sized rings (i.e. rings having an outer diameter equal to or greater than 0.5 m, greater than 1 m, greater than 2 m or greater than 3 m).

According to an embodiment of the invention the method comprises the step of carburizing at least part of a surface of the steel in the vicinity of the subsequent butt weld joint, which surface is adjacent to the surface that is to be flash butt welded, prior to said flash butt welding. Carbon at that surface will be carried towards the colder zone of the heated metal, i.e. towards the inside and outside surfaces of a welded component, such as a welded bearing ring or welded bearing ring segment which may subsequently constitute raceway surfaces, rather than remain in the vicinity of the weld joint. The displaced carbon will therefore further increase the surface hardness, wear resistance and/or fatigue and tensile strength of the welded component at its inside and outside surfaces. Such a method provides a welded component having a superior weld joint that is free, or substantially free of carbon, and without areas of structural weakness as might otherwise occur. Such a method consequently provides an improved welded component having a high degree of structural integrity.

Alternatively, a component may be carburized after the flash butt welding step in order to increase its surface hardness, wear resistance and/or fatigue and tensile strength.

According to a further embodiment of the invention the method comprises the step of profiling at least one steel bar before it is formed into at least one ring segment. In the step of profiling the at least one steel bar may be cut to the required dimensions using a method such as flame cutting, laser cutting, water jet cutting or plasma cutting. According to an embodiment of the present invention a carburizing step may be carried out prior to the profiling step.

According to an embodiment of the invention the steel having a carbon content of 0.1-1.1 weight-%, preferably 0.6-1.1 weight-%, or most preferably 0.8-1.05 weight-%.

According to an embodiment of the invention the method comprises the step of removing any welding accretion, containing slag, oxides and/or molten metal for example, after the flash butt welding step.

According to a further embodiment of the invention the steel has the following composition in weight-%:
C 0.5-1.1
Si 0-0.15
Mn 0-1.0
Cr 0.01-2.0
Mo 0.01-1.0
Ni 0.01-2.0
V and/or Nb 0.01-1.0 of V or 0.01-1.0 of Nb, or 0.01-1.0 of both elements
S 0-0.002
P 0-0.010
Cu 0-0.15
Al 0.010-1.0
the remainder being Fe and normally occurring impurities.

By minimizing the silicon content, and reducing the manganese and chromium content of the steel (which are alloying elements that are easily oxidised) to the levels indicated above, the steel will be more stable and will not be as easily oxidised during flash butt welding. The sulphur content of the steel is reduced to an absolute minimum whereby the content of non-desirable non-metallic inclusions in steel that has been subjected to flash butt welding will be minimized. A high level of through-thickness ductility may be obtained by means of a special ladle treatment during steelmaking which ensures very low sulphur content and a controlled shape of non-metallic inclusions.

The phosphorus content of the steel is also reduced to an absolute minimum in order to hinder residual or tramp elements in the steel migrating to austenite grain boundaries when the steel is subjected to flash butt welding, which will significantly weaken the weld zone. The addition of molybdenum, nickel and optionally vanadium provides steel with a hardenability sufficient to enable through-hardening of large components (i.e. a DI of 400 mm or more).

The adverse effects of the unfavourable material flow that flash butt welding creates may therefore be limited by using such steel. Using such steel namely provides a joined/welded component having a superior joint/weld since the joined/welded component does not contain areas of structural weakness as might otherwise occur. Such a joined/welded component therefore has a high degree of structural integrity compared to joined/welded component that does not comprise such steel. Such steel is therefore suitable for flash butt welding and in particular for the manufacture of components intended for an application with high demands on fatigue and toughness properties, which components are to be subjected to flash butt welding during or after their manufacture.

The present invention also concerns a ring manufactured using a method according to an embodiment of the invention. The ring is manufactured by forming at least one steel bar into at least one ring segment and flash butt welding the ends of the at least one ring segment, whereby the at least one steel bar has a reduction ratio of greater than 5:1. The total number of inclusions in such a highly reduced steel bar is greater than in a corresponding less reduced steel bar of the same steel and of the same dimensions, and the average inclusion size is smaller.

Further embodiments of the ring according to the present invention are recited in the claims.

The present invention also concerns a bearing that comprises at least one ring according to an embodiment of the invention. The bearing may be a roller bearing, a needle bearing, a tapered roller bearing, a spherical roller bearing, a toroidal roller bearing, a thrust bearing or a bearing for any application in which is subjected to alternating Hertzian stresses, such as rolling contact or combined rolling and sliding. The bearing may for example be used in automotive wind, marine, metal producing or other machine applications which require high wear resistance and/or increased fatigue and tensile strength.

### BRIEF DESCRIPTION OF THE DRAWINGS

The present invention will hereinafter be further explained by means of non-limiting examples with reference to the appended schematic figures where;

FIGS. 1-3 show steps of a method according to an embodiment of the invention,

FIG. 4 shows a bearing ring after a flash butt welding step according to an embodiment of the invention,

FIG. 5 shows the steps of a method according to an embodiment of the invention, and

FIG. 6 shows a bearing according to an embodiment of the invention.

It should be noted that the drawings have not been drawn to scale and that the dimensions of certain features have been exaggerated for the sake of clarity.

### DETAILED DESCRIPTION OF EMBODIMENTS

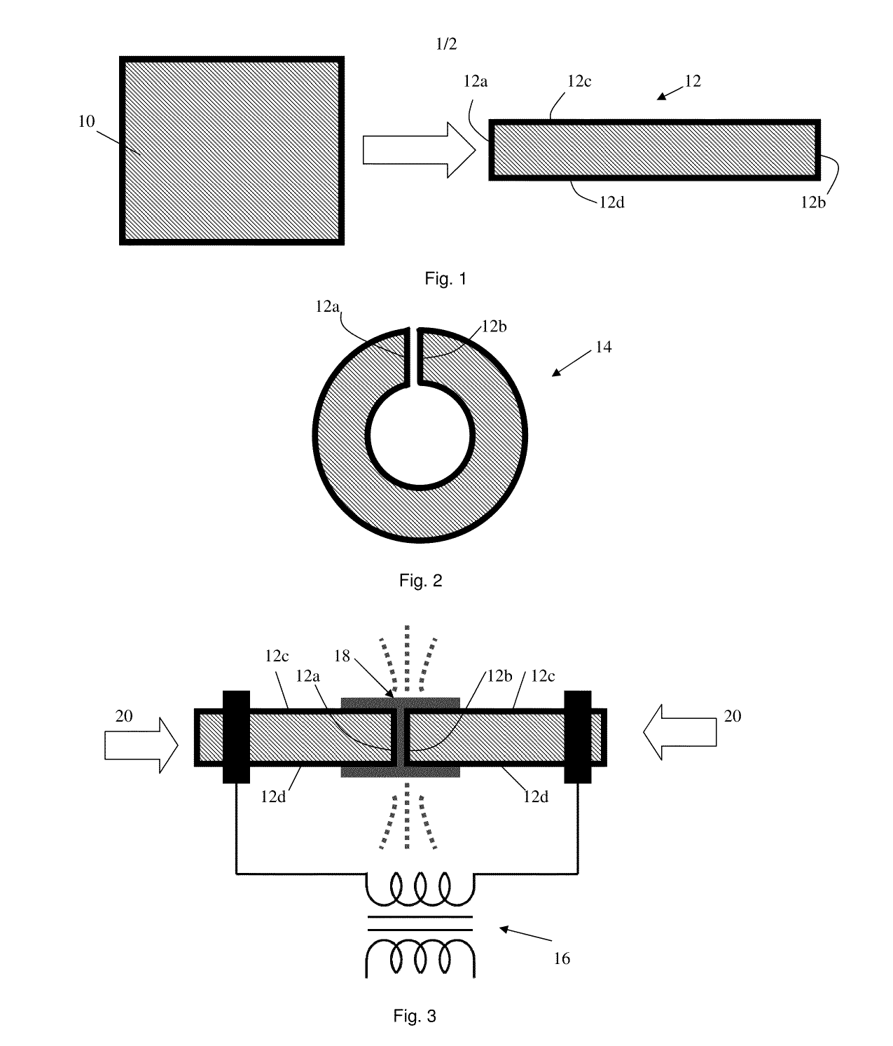

FIGS. 1-3 schematically show various method steps of a method according to an embodiment of the invention. FIG. 1 shows steel 10 that is forged to produce a steel bar 12 having two opposed ends 12a and 12b and a reduction ratio greater than 5:1.

It should be noted that the ends 12a, 12b of the steel bar 12 shown in the illustrated embodiment comprise ends that form an angle of 90° to a side surface 12c, 12d of the steel bar 12. A steel bar 12 may however comprise an end 12a, 12b that forms an angle greater or less than 90° to a side surface 12c, 12d of a steel bar, a steel bar 12 may namely comprise diagonally sloping ends. Furthermore, the ends 12a and 12b of the steel bar 12 need not necessarily have a flat surface.

At least one part of at least one surface 12a, 12b, 12c, 12d of the steel bar may be carburized prior to flash butt welding. For example, the opposed ends may be uniformly or non-uniformly carburized to form a continuous or non-continuous carburized layer using any conventional method in which the steel bar is heated in the presence of another material that liberates carbon as it decomposes and then cooled rapidly by quenching.

FIG. 2 shows a single steel bar 12 that has been formed into an open bearing ring 14. It should be noted that each of a plurality of steel bars 12 may alternatively be formed into a plurality of ring segments, whereby two or more ring segments may then be flash butt welded together to form a bearing ring 14.

FIG. 3 shows the ends 12a, 12b of an open bearing ring 14 being flash butt welded together. The ends 12a, 12b of the open bearing ring 14 are clamped and brought together at a controlled rate and current from a transformer 16 is applied. An arc is created between the two ends 12a, 12b. At the beginning of the flash butt welding process, the arc gap 18 is large enough to even out and clean the two surfaces 12a, 12b. Reducing and then closing and opening the gap 18 creates heat in the two surfaces 12a, 12b. When the temperature at the two surfaces 12a, 12b has reached the forging temperature, pressure is applied in the directions of block arrows 20 in FIG. 3 (or a moveable end is forged against a stationary end). A flash is created between the two surfaces 12a, 12b, which causes any carbon in the welding area to flow radially outwards from the surfaces 12a, 12b towards the inside and outside surfaces 12c, 12d of the bearing ring, resulting in a clean weld joint.

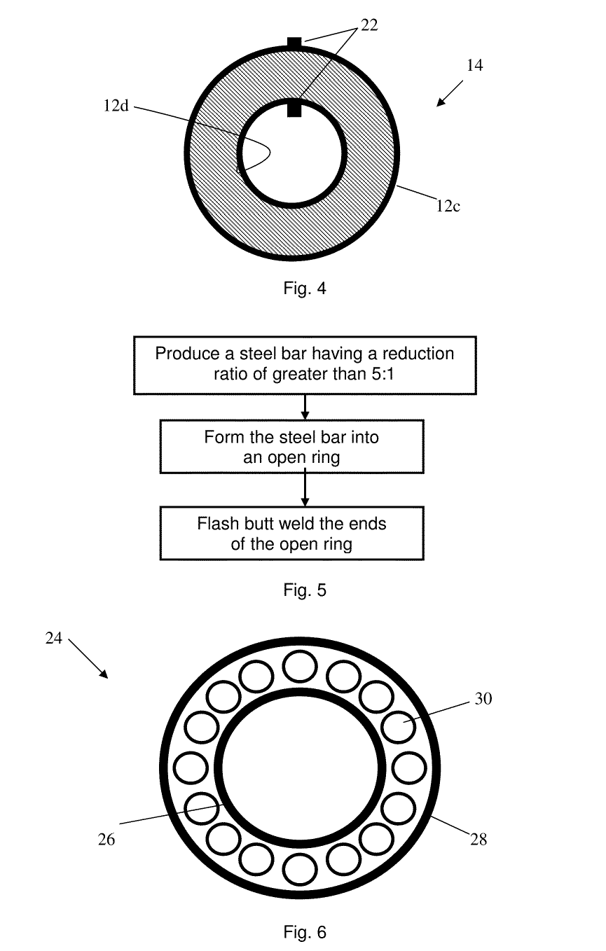

After cooling in a water-, oil- or polymer-based quench for example, any welding accretion 22 (shown in FIG. 4) which accumulates on the inner and outer surfaces 12d and 12c of the welded bearing ring may be removed. According to an embodiment of the invention the welded bearing ring may be subjected to a second heat treatment and upsetting force to further improve its structural integrity.

FIG. 5 shows various steps of a method for manufacturing a component, namely a ring, from steel, namely from a steel bar, according an embodiment of the present invention. The method comprises the steps of producing a steel bar having a reduction ratio of greater than 5:1, forming the bar into an open ring and flash butt welding the ends of the open bearing ring. The steel bar may be profiled before it is formed into the ring.

FIG. 6 shows an example of a bearing 24, namely a rolling element bearing that may range in size from 10 mm diameter to a few metres diameter and have a load-carrying capacity from a few tens of grams to many thousands of tonnes. The bearing 24 according to the present invention may namely be of any size and have any load-carrying capacity. The bearing 24 has an inner ring 26 and an outer ring 28, one or both of which may be constituted by a ring according to the present invention, and a set of rolling elements 30. The inner ring 26, the outer ring 28 and/or the rolling elements 30 of the rolling element bearing 24, and preferably all of the rolling contact parts of the rolling element bearing 24 are manufactured from steel that comprises 0.20 to 0.40 weight-% carbon.

Further modifications of the invention within the scope of the claims will be apparent to a skilled person.

1. A method for manufacturing a component ( from steel, which comprises the step of flash butt welding the component, characterized in that said steel has a reduction ratio of greater than 5:1.

2. The method according to claim 1, wherein component is a ring and said method comprises the step of manufacturing said ring from at least one steel bar having ends, forming said at least one steel bar into at least one ring segment and flash butt welding the ends of said at least one ring segment to make a ring.

3. The method according to claim 1, further comprising a step of producing one of a forged slab, bloom, or billet having a reduction ratio of greater than 5:1.

4. The method according to claim 2, further comprising a step of forming a plurality of steel bars into a plurality of ring segments where each ring segment constitutes equal to or less than 50%, of a ring when said ring segments have been flash butt welded together to make said ring.

5. The method according to claim 2, further comprising a step of profiling said at least one steel bar before it is formed into said at least one ring segment.

6. The method according to claim 1, wherein said steel has a carbon content of 0.1-1.1 weight %.

7. The method according to claim 1, further comprising a step of removing any welding accretion after said flash butt welding step.

8. The method according to claim 1, wherein said component is a bearing ring.

9. The method according to claim 2, wherein said ring has an outer diameter equal to or greater than 0.5 m.

10. The method according to claim 1 wherein said steel has the following composition in weight-%:
C 0.5-1.1%
Si 0-0.15%
Mn 0-1.0%
Cr 0.01-2.0%
Mo 0.01-1.0%
Ni 0.01-2.0%
at least one of V and/or Nb 0.01-1.0% of V or 0.01-1.0% of Nb, or 0.01-1.0% of both elements
S-0.002%
P 0-0.010%
Cu 0-0.15%
Al 0.010-1.0%, and
a balance of Fe and normally occurring impurities.

11. Ring A ring manufactured by forming at least one steel bar (12) into at least one ring segment and flash butt welding the ends of said at least one ring segment, wherein said at least one steel bar has a reduction ratio of greater than 5:1.

12. The ring according to claim 11, wherein said ring is formed from a plurality of ring segments where each ring segment constitutes equal to or less than 50%, of said ring when said ring segments have been flash butt welded together to make said ring.

13. The ring according to claim 11, wherein said at least one steel bar comprises steel having a carbon content of 0.1-1.1 weight %.

14. The ring according to claim 11, wherein said ring is a bearing ring, of a bearing.

15. The ring according to claim 11, wherein said ring has an outer diameter equal to or greater than 0.5 m.

16. The ring according to claim 11, wherein said at least one steel bar has the following composition in weight-%:
C 0.5-1.1%
Si 0-0.15%
Mn 0-1.0%
Cr 0.01-2.0%
Mo 0.01-1.0%
Ni 0.01-2.0%
at least one of V and Nb 0.01-1.0% of V or 0.01-1.0% of Nb, or 0.01-1.0% of both elements
S 0-0.002%
P 0-0.010%
Cu 0-0.15%
Al 0.010-1.0%, and
a balance of Fe and normally occurring impurities.

17. The ring according to claim 11, wherein the ring is integrated as a component of a bearing.
